(19) United States
(12) Patent Application Publication
(10) Pub. No.: US 2026/0188035 A1
(43) Pub. Date: Jul. 2, 2026

(54) METHOD FOR CAPTURING IDENTIFICATION CARD IMAGE AND ELECTRONIC DEVICE FOR PERFORMING THE SAME

(71) Applicant: Toss Bank, Seoul (KR)

(72) Inventors: Minjung Chung, Seoul (KR); Hyunho Cho, Seoul (KR); Kyung Yoon Kim, Seoul (KR); Jun Ho Lee, Seoul (KR); Jiwoo Jeong, Seoul (KR); Dong Hun Kang, Seoul (KR); Jayoung Seo, Seoul (KR)

(21) Appl. No.: 19/423,644

(22) Filed: Dec. 17, 2025

(30) Foreign Application Priority Data
Dec. 18, 2024 (KR) 10-2024-0189834

(51) Int. Cl. G06V 30/146; G06V 10/24; G06V 10/764; G06V 10/98; G06V 30/12; G06V 30/42; H04N 23/66

(52) U.S. Cl. CPC G06V 30/1468; G06V 10/245; G06V 10/764; G06V 10/993; G06V 30/133; G06V 30/42; H04N 23/66

(57) ABSTRACT

A method for capturing an identification (ID) card image including determining whether an ID card within an image received via a sensor is positioned according to a pre-set guide line; acquiring an ID card image based on the guide line if it is determined that the ID card is positioned according to the pre-set guide line, inputting the ID card image into a first artificial intelligence model to determine whether the ID card contained in the ID card image corresponds to one of pre-set ID card types, determining whether user information within the ID card image is identifiable, and capturing the ID card image if it is determined that the user information within the ID card image is identifiable, and an electronic device for performing the same are disclosed.

### CROSS-REFERENCE TO RELATED APPLICATION(S)

This application claims the benefit of Korean Patent Application No. 10-2024-0189834, filed on Dec. 18, 2024, in the Korean Intellectual Property Office, the disclosure of which is incorporated herein by reference.

### BACKGROUND

### 1. Field of the Invention

The present disclosure relates to a method for capturing an identification card image and an electronic device for performing the same.

### 2. Description of the Related Art

Non-face-to-face financial services, which allow users to access financial services online without visiting banks or financial institutions in person, are increasing. To enhance the security of financial service provision, prevent fraud during service use, and ensure compliance with various regulations, it is important to rigorously verify user identity when providing non-face-to-face financial services. In this regard, various approaches are being attempted to improve the user experience by providing guidance to ensure users can properly capture their identification card images when submitting them for identity verification before financial services are provided.

### SUMMARY

An aspect provides a method that allows users attempting to capture identification card images to easily resolve errors occurring during the capture process by providing more accurate and prompt feedback to the users during the identification card image capture process by determining in real time whether identification card images submitted by the users seeking to use financial services have been captured appropriately for the purpose of providing financial services.

Another aspect provides a method for capturing an identification card image and an electronic device that may enhance the reliability of the mobile identification recognition service by performing optical character recognition only on identification card images deemed appropriately submitted and by requiring users to submit more precise identification card images based on the optical character recognition results.

The technical aspects of the present disclosure are not limited to those mentioned above, and other technical aspects can be inferred from the following embodiments.

According to an embodiment, there is provided a method for capturing an identification (ID) card image including determining whether an ID card within an image received via a sensor is positioned according to a pre-set guide line, acquiring an ID card image based on the guide line if it is determined that the ID card is positioned according to the pre-set guide line, inputting the ID card image into a first artificial intelligence (AI) model to determine whether the ID card contained in the ID card image corresponds to one of pre-set ID card types, determining whether user information within the ID card image is identifiable, and capturing the ID card image if it is determined that the user information within the ID card image is identifiable.

The method according to an embodiment may further include controlling a user terminal to display detailed information about the pre-set ID card types required to be obtained in order to capture the ID card image if it is determined that the ID card contained in the ID card image does not correspond to any of the pre-set ID card types.

The determining of whether the ID card is positioned according to the pre-set guide line may include determining whether an area corresponding to the ID card within the image received via the sensor satisfies pre-set conditions based on an area corresponding to the pre-set guide line.

The method according to an embodiment may further include controlling a user terminal to display detailed information about the pre-set guide line where the area corresponding to the ID card to be placed for capturing the ID card image if it is determined that the area corresponding to the ID card is not positioned according to the pre-set guide line.

The determining of whether the user information within the ID card image is identifiable may include acquiring information of a first area in the ID card image related to the user information and information of a second area in the ID card image related to image defects and determining whether the user information within the ID card image is identifiable based on the information of the first area and the information of the second area.

The information of the first area may include coordinate information of the first area on the ID card image. The information of the second area may include coordinate information of the second area on the ID card image. The determining of whether the user information within the ID card image is identifiable may include determining whether the first area and the second area overlap based on the coordinate information of the first area and the coordinate information of the second area, obtaining a ratio concerning a degree of overlap if it is determined that the first area overlaps with the second area, and controlling a user terminal to display first detailed information about the user information for capturing the ID card image if the ratio concerning the degree of overlap exceeds a first threshold.

The ratio concerning the degree of overlap may be determined based on a ratio of a size of an area where the first area and the second area overlap to a size of the first area.

The first threshold may have a predefined value based on an importance of the user information contained within the first area.

The obtaining of the ratio concerning the degree of overlap may include obtaining, when there are multiple second areas, a ratio of a total sum of sizes of overlapping areas of the first area and the second area to the size of the first area. The controlling of the user terminal to display the first detailed information about the user information for capturing the ID card image may include controlling the user terminal to display the first detailed information about the user information if the ratio of the total sum of the sizes of the overlapping areas exceeds the first threshold.

The method according to an embodiment may further include identifying a number of the first areas where a ratio of a total sum of the sizes of overlapping areas with the second area exceeds the first threshold and controlling the user terminal to display second detailed information about the user information for capturing the ID card image if the number of the first areas is equal to or greater than a preset value.

The determining of whether the user information within the ID card image is identifiable may include determining that the user information for capturing the ID card image is obtainable if it is determined that the first area does not overlap with the second area.

The method according to an embodiment may further include performing, after capturing the ID card image, optical character recognition (OCR) on the captured ID card image and, after performing the OCR, if characters included in the user information of the captured ID card image are not recognized, reacquiring the ID card image within the image received via the sensor.

The reacquiring of the ID card image may include acquiring information about a first area in the reacquired ID card image related to user information and information about a second area in the reacquired ID card image related to image defects, re-determining whether the user information within the reacquired ID card image is identifiable based on the reacquired information of the first area and the reacquired information of the second area, and re-capturing the ID card image if the user information within the reacquired ID card image is identifiable. The re-determining of whether the user information within the reacquired ID card image is identifiable may include reacquiring a ratio concerning a degree of overlap between the first area and the second area within the reacquired ID card image. The re-capturing of the ID card image may include re-capturing the ID card image when the ratio concerning the degree of overlap is less than or equal to a second threshold which is below the first threshold.

The method according to an embodiment may further include transmitting, when the characters included in the user information of the captured ID card image are recognized, a verification request for the user information of the ID card image to an external server and receiving a response corresponding to the verification request.

According to an embodiment, there is provided an electronic device for performing a method for capturing an ID card image, the electronic device including a sensor configured to receive an image, a memory, and a processor coupled to the memory. The processor may be configured to determine whether an ID card within an image received via a sensor is positioned according to a pre-set guide line, acquire an ID card image based on the guide line if it is determined that the ID card is positioned according to the pre-set guide line, input the ID card image into a first AI model to determine whether the ID card contained in the ID card image corresponds to one of pre-set ID card types, determine whether user information within the ID card image is identifiable, and capture the ID card image if it is determined that the user information within the ID card image is identifiable.

Specific details of other embodiments are included in the detailed description and drawings.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating the interconnection of an electronic device performing a method for capturing an identification (ID) card image according to an example embodiment;

FIG. 2 is a diagram illustrating a process of providing detailed information regarding a pre-set guide line for acquiring an ID card image in a method for capturing an ID card image according to an embodiment;

FIGS. 3A and 3B are diagrams illustrating a process for providing detailed information about ID card types in a method for capturing an ID card image according to an embodiment;

FIG. 4 is a diagram illustrating a process for detecting a first area and a second area to provide detailed information about user information in a method for capturing an ID card image according to an embodiment;

FIGS. 5A, 5B, 5C, 5D, 5E, and 5F are diagrams illustrating an embodiment for detecting a first area and a second area on an ID card image in a method for capturing an ID card image according to an embodiment;

FIGS. 6A and 6B are diagrams illustrating a process for providing detailed information about user information in a method for capturing an ID card image according to an embodiment;

FIG. 7 is a flowchart illustrating an overall process of capturing an ID card image in a method for capturing an ID card image according to an embodiment;

FIG. 8 is a flowchart illustrating an overall process of providing detailed information about user information in a method for capturing an ID card image according to an embodiment;

FIG. 9 is a flowchart illustrating an overall process of performing user information verification after capturing an ID card image in a method for capturing an ID card image according to an embodiment;

FIGS. 10A and 10B are diagrams illustrating an example of providing a verification result of an ID card in a method for capturing an ID card image according to an embodiment; and

FIG. 11 is a block diagram showing the structure of an electronic device performing a method for capturing an ID card image according to an embodiment.

### DETAILED DESCRIPTION

The terms used in embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “comprises” or “includes” a certain component, it means that other components may further be included, and it does not preclude other components, unless otherwise stated.

The expression “at least one of A, B, and C” may indicate the following meaning including: A alone; B alone; C alone; both A and B together; both A and C together; both B and C together; or all three of A, B, and C together.

The “terminal” mentioned herein may be implemented as a computer or a portable terminal that can access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, and the like.

In the following, with reference to the accompanying drawings, embodiments of the present disclosure will be described in detail so that those skilled in the art to which the present disclosure pertains may easily implement them. However, the present disclosure may be implemented in various different forms and is not limited to the embodiments described herein.

Hereinafter, embodiments of the present disclosure will be described in detail with reference to the drawings.

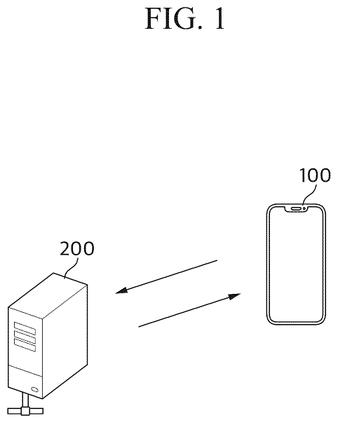

FIG. 1 is a diagram illustrating the interconnection of an electronic device performing a method for capturing an identification (ID) card image according to an embodiment.

Referring to FIG. 1, an electronic device 100 according to an embodiment may operate in conjunction with an external server 200. The electronic device 100 and the external server 200 may each include memory and a processor. Furthermore, the electronic device 100 and the external server 200 may each be divided into units based on at least one function or operation to be handled, which may be implemented as hardware, software, or a combination of hardware and software. Throughout embodiments, the electronic device 100 and the external server 200 are referred to as a separate device and a server. However, this functional distinction is for explanatory convenience. The electronic device 100 and the external server 200 may have a logically divided structure or may be implemented by separate functions within a single device or server.

According to an embodiment, the electronic device 100 and the external server 200 may include a plurality of computer systems or computer software implemented as network servers. For example, at least some of the electronic device 100 and the external server 200 may refer to computer systems and computer software connected to a sub-device capable of communicating with other network servers via a computer network such as an intranet or the internet, receiving requests to perform tasks, performing the tasks in response, and providing the results of the tasks. Furthermore, at least some of the electronic device 100 and external server 200 may be understood in a broad sense as including a series of applications operable on a network server and various databases built therein. For example, at least some of the electronic device 100 and external server 200 may be implemented using network server programs provided in various forms depending on the operating system, such as DOS, Windows, Linux, UNIX, or macOS. For convenience of explanation, each operational entity has been referred to as the electronic device 100 and the external server 200. However, these should be understood as encompassing a comprehensive form of device that may correspond to, include, or be contained within various types of devices, such as computer devices and mobile communication terminals.

The electronic device 100 may be a device that acquires and provides various pieces of information. The electronic device 100 may perform various tasks to provide services to a user. The services provided to the user may include, but are not limited to, various online financial services such as internet banking, electronic payments, financial investment services, online loans, financial advisory services, and financial insurance services.

More specifically regarding the operation of the electronic device 100, the electronic device 100 may acquire an image received via a sensor. In an embodiment, the image received via the sensor may refer to the entire image data or video data captured by the sensor of the electronic device 100. In an embodiment, the electronic device 100 determines whether an ID card is positioned according to a pre-set guide line within the image received via the sensor. If the ID card is determined to be positioned according to the pre-set guide line, the electronic device 100 may acquire an ID card image based on the guide line. In an embodiment, the ID card image may refer to an ID card image obtained by preprocessing the image received by the electronic device 100 via the sensor, inputting it into an artificial intelligence (AI) model, and recognizing specific areas such as the border of the ID card using a computer vision technology (e.g., an object detection algorithm). The electronic device 100 may acquire the ID card image based on the guide line when it determines that an ID card is positioned according to the pre-set guide line within the image received via the sensor. For example, the electronic device 100 may acquire an image included within the guide line from the image received via the sensor as the ID card image. When the ID card image is acquired according to an embodiment, the electronic device 100 provides the user with various pieces of detailed information, including information for capturing the ID card image, based on whether the ID card contained in the acquired ID card image corresponds to one of the pre-set ID card types and whether user information is identifiable within the ID card image. This provides feedback to the user to properly capture the image through the sensor of the electronic device 100 or enables the capture of the ID card image. Here, the process by which the electronic device 100 determines whether the user information is identifiable before capturing the ID card image may correspond to the process of ascertaining whether the ID card image contains image defects that would make it substantially difficult to obtain the user information. Therefore, the electronic device 100 does not need to acquire specific personal information contained in the user information prior to the step of capturing the ID card image. It may acquire specific personal information later through an optical character recognition process using the captured ID card image.

A user utilizing the electronic device 100 may correspond to an entity receiving services (e.g., using financial services) through a terminal connected to the internet. The electronic device 100 may be a device operated and managed by the user. The electronic device 100 may receive a user input, including an ID card image, from the user or others, or receive information from an external server 200 or others, and perform corresponding actions. For example, the electronic device 100 may obtain a page for using a service from the external server 200 and provide it to the user (e.g., display it on a screen). Alternatively, the electronic device 100 may obtain information that serves as a basis for constructing a page from the external server 200, and based on this information, construct the page and provide it to the user. Furthermore, the electronic device 100 may obtain an input associated with the use of a service from the external server 200, and either deliver the obtained input to the user or deliver information generated based on the obtained input to the user.

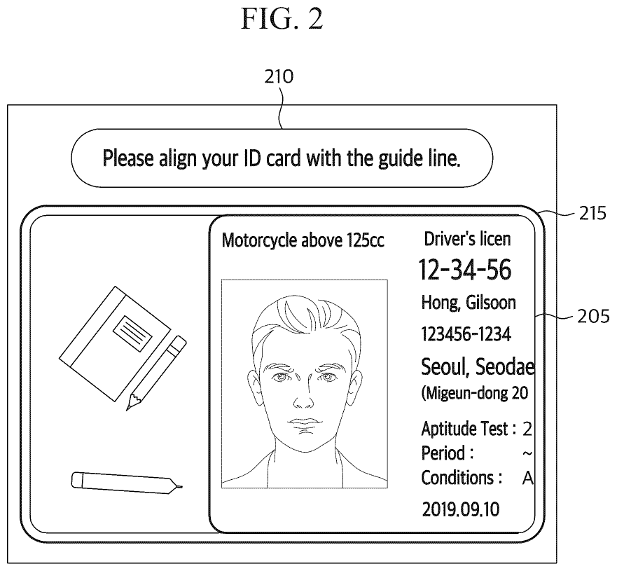

In an embodiment, the external server 200 may perform operations of receiving a verification request for user information from the electronic device 100 and then transmitting a response corresponding to the verification request to the electronic device 100. For example, the external server 200 may correspond to a server related to an institution providing identity verification services for ID cards such as passports, resident registration cards, driver's licenses, and alien registration cards, such as the Korea Financial Telecommunications & Clearings Institute. For example, the external server 200 may verify the match between the name of the user and ID card number of the user, between the name of the user and resident registration number of the user, between the name of the user and alien registration number of the user, and between the ID card issuance date and resident registration number of the user within the ID card image received from the electronic device 100. The external server 200 may perform the operation of transmitting a response to the electronic device 100 in response to the verification request, which includes information regarding verification confirmation or verification failure based on the confirmation of the match for the user information. The operation of the external server 200 transmitting a response to the verification request based on the ID card image received from the electronic device 100 is described in more detail below. More detailed aspects concerning the electronic device 100 and the external server 200 are described later in FIGS. 2 to 11.

A series of operations related to capturing ID card images according to various embodiments may be implemented by a single physical device or by a plurality of physical devices organically combined. For example, some components of the electronic device 100 or the external server 200 may be implemented by one physical device, while the remaining components may be implemented by another physical device. For instance, one physical device may be implemented as part of the electronic device 100, while another physical device may be implemented as part of the external server 200 or part of another external device. In some cases, each component included in the electronic device 100 may be distributed and deployed across different physical devices, and these distributed components may be organically combined to implement the functions and operations of the electronic device 100. For example, the electronic device 100 of the present specification may include at least one sub-device, and some operations described as being performed by the electronic device 100 may be performed by a first sub-unit, while other operations may be performed by a second sub-unit.

FIG. 2 is a diagram illustrating a process of providing detailed information regarding a pre-set guide line for acquiring an ID card image in a method for capturing an ID card image according to an embodiment.

Referring to FIG. 2, the electronic device 100 performing the method for capturing an ID card image according to an embodiment determines whether an ID card 205 is positioned according to a pre-set guide line 215 within an image received via a sensor. If it is determined that the ID card 205 is positioned according to the pre-set guide line 215, the ID card image may be acquired based on the guide line 215.

The electronic device 100 may determine that the ID card 205 is positioned according to the pre-set guide line 215 if the area corresponding to the ID card 205 within the image received through the sensor satisfies a predefined condition based on the area corresponding to the pre-set guide line 215. In an embodiment, the predefined condition may be based on the positional relationship between the guide line 215, which may include various specific shapes such as a rectangle, circle, or grid, and a bounding box encompassing the area corresponding to the ID card 205 obtained through object detection. For example, the predefined condition may include a condition where the overlap ratio between the guide line and the bounding box containing the area corresponding to the ID card 205 is 1 or less and exceeds a predefined overlap ratio. Through this, the electronic device 100 may provide detailed information 210 about the guide line when the area corresponding to the ID card 205 is acquired too small, too large, or when a part of the area corresponding to the ID card 205 is cut off on the pre-set guide line.

More specifically, as shown in FIG. 2, the electronic device 100 may control a user terminal to display detailed information 210 about the pre-set guide line where the area corresponding to the ID card 205 should be positioned, if it determines that the area corresponding to the ID card 205 is not positioned according to the pre-set guide line. According to an embodiment, the user terminal may be defined as a terminal used by a user who communicates with the electronic device 100 to request verification of the ID card. According to an embodiment, the pre-set guide line 215 may be determined as a line surrounding a box-shaped area containing a portion of the image received via the sensor. In an embodiment, the detailed information 210 about the pre-set guide line 215 may include detailed information 210 instructing the user terminal to align the ID card with the guide line 215. In the process of providing the detailed information 210 about the pre-set guide line 215, the electronic device 100 may put emphasis on the pre-set guide line 215 (e.g., highlight the pre-set guide line 215). The detailed information 210 about the pre-set guide line 215 according to an embodiment may be displayed on the display of the user terminal at the at least one area of top, bottom, left, or right of the area corresponding to the ID card 205. It may also be provided on a portion of the area corresponding to the ID card 205 by overlapping with a part of that area.

For example, if the area corresponding to the ID card 205 is appropriately modified within the re-captured image to reflect the detailed information 210 about the pre-set guide line, the electronic device 100 may determine that the area corresponding to the ID card 205 within the image received via the sensor satisfies the pre-set condition based on the area corresponding to the pre-set guide line 215. According to an embodiment, various image isolation techniques may be utilized to extract the area corresponding to the ID card 205 within the image captured by the electronic device 100 in order to obtain the ID card image. Therefore, providing the guide line 215 for obtaining the ID card image may be for acquiring the ID card image at an optimized resolution for utilizing these image isolation techniques. In an embodiment, the electronic device 100 may also acquire the ID card image based on the guide line 215. The electronic device 100 may acquire the ID card image by performing correction for the gradient, position, and size of the area corresponding to the ID card 205 within the image encompassed by the guide line 215.

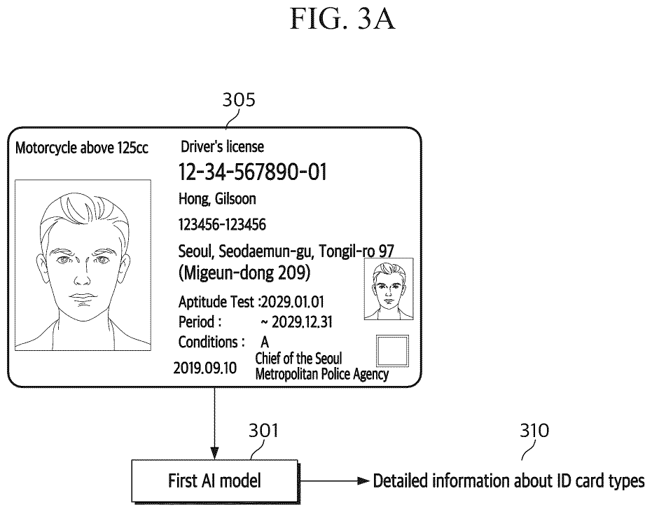

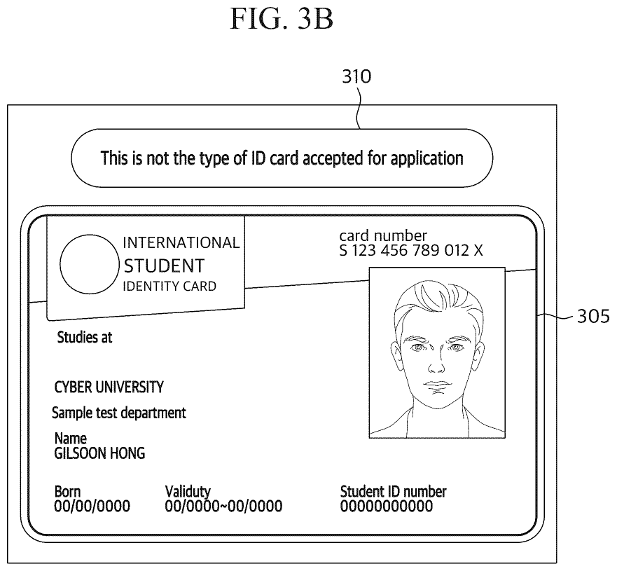

FIGS. 3A and 3B are diagrams illustrating a process for providing detailed information about ID card types in a method for capturing an ID card image according to an embodiment.

Referring to FIG. 3A, the electronic device 100 performing the method for capturing an ID card image according to an embodiment may acquire an ID card image 305, when it determines that an ID card is positioned within an image received via the sensor according to the pre-set guide line, and input the ID card image 305 to a first AI model 301 to determine whether the ID card contained in the ID card image 305 corresponds to one of pre-set ID card types. For example, the ID card image 305 may refer to an image recognized by the first AI model 301 as having the form of an ID card among the images received by the electronic device 100 via the sensor.

The first AI model 301 according to an embodiment may correspond to a model running in a mobile environment based on, for example, the TensorFlow framework. The first AI model 301 may correspond to an AI model that has been lightweighted through the application of quantization. The first AI model 301 may correspond to a model that minimizes the capacity of the model, binary and parameters, without performing data communication to a separate server during the training and operation processes of the first AI model 301. The electronic device 100 according to an embodiment may minimize unnecessary leakage of personal information externally and enable rapid feedback on images received via sensors throughout the entire process of determining the type of ID card within the ID card image 305, determining whether the ID card image 305 is positioned according to the pre-set guide line, and determining whether user information within the ID card image 305 is identifiable, through the use of the first AI model 301. Hereinafter, details overlapping with features previously described regarding the operation of the first AI model 301 are omitted.

For example, the first AI model 301 may receive an image input received by the electronic device 100 through the sensor, and then determine whether the ID card contained within the ID card image 305 corresponds to one of the pre-set ID card types based on the vector of the ID card image 305 contained within the image. For example, the first AI model 301 may be trained to determine the type of ID card based on images that fall within the form of ID cards contained within images received by the electronic device 100 via the sensor, using a large volume of images as input. For example, the first AI model 301 may be trained to predict the probability that an ID card included in the predefined ID card types exists within an image (or an image obtained therefrom) received by the electronic device 100 via the sensor. More specifically, the first AI model 301 may be trained to predict the probability that an ID card included in the predefined ID card types exists in the area corresponding to specific coordinates within the received image, as well as the specific coordinates themselves. For example, the first AI model 301 may be trained to divide an image into a grid of a preset size and predict the probability that an ID card included in the predefined ID card types exists in the corresponding area of each grid cell. The first AI model 301 may be trained based on data obtained through labeling on image data collected from the ID card images 305 included in the predefined ID card types and preprocessing for each image, including noise removal, resizing, and brightness adjustment. The first AI model 301 may be an AI model trained to accurately classify ID card types by learning the visual features of ID card images 305. For example, the first AI model 301 may be an AI model trained to predict the type of an ID card when a new ID card image 305 is input. The first AI model 301 may be an AI model trained to analyze the input ID card image 305 to determine what type of ID card the ID card image 305 corresponds to by comparing it with patterns in the training data and output the result.

Referring to FIG. 3B, the electronic device 100 according to an embodiment inputs the ID card image 305 into the first AI model 301, and if it determines, based on the output obtained from the first AI model 301, that the ID card included in the ID card image 305 does not correspond to any of the pre-set ID card types, it may control the user terminal to display detailed information 310 about the pre-set ID card type that should be acquired for the capture to proceed. In an embodiment, the user terminal may correspond to the electronic device 100 as described above. In an embodiment, the detailed information 310 about the pre-set ID card type may include information that the ID card type corresponding to the ID card image 305 acquired via the sensor included in the electronic device 100, as shown in FIG. 3B, is not included among the pre-set ID card types required in the user authentication process for financial services. In an embodiment, the detailed information 310 about the pre-set ID card types may include information such as the type of ID card required during the user authentication process for financial services (e.g., “Please capture your resident registration card,” “Please capture your driver's license”). The detailed information 310 about the pre-set ID types according to an embodiment may be displayed in at least one area among the top, bottom, left, or right of the ID card image 305 on the display of the user terminal, and may also be provided within a certain area inside the ID card image 305 by overlapping with a part of the ID card image 305.

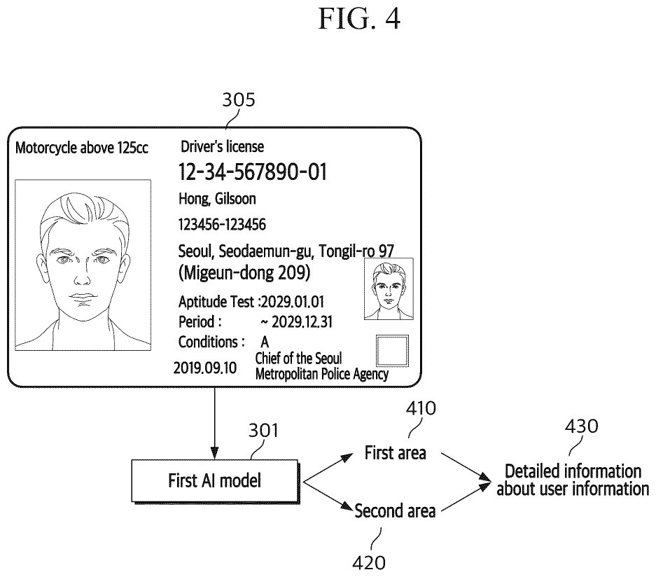

FIG. 4 is a diagram illustrating a process for detecting a first area and a second area to provide detailed information about user information in a method for capturing an ID card image according to an embodiment.

Referring to FIG. 4, the electronic device 100 according to an embodiment inputs the ID card image 305 into the first AI model 301 to obtain information of a first area 410 related to user information within the ID card image 305 and information of a second area (420) related to image defects within the ID card image 305. Based on the information of the first area and the information of the second area, it may determine whether the user information within the ID card image 305 is identifiable, and control the user terminal to display detailed information 430 about the user information. In an embodiment, after receiving the ID card image 305 as input, the first AI model 301 may recognize the location of the first area 410 related to the user information and the location of the second area 420 related to the image defects within the ID card image 305 vector. For example, the first AI model 301 may be trained using a large number of ID card images 305 as input to recognize the location of the first area related to the user information and the location of the second area related to the image defects within each ID card image 305. That is, the electronic device 100 may train the first AI model 301 to identify the location of the first area 410, which is the location where the user information may be obtained, for each type of ID card, and further train the first AI model 301 to identify the location of the second area 420 related to the image defects for each type of ID card. According to an embodiment, the first area and the second area may be box-shaped areas. The first AI model 301 may obtain coordinate information of the box-shaped areas including information of the recognized first area 410 and information of the recognized second area 420. That is, the first AI model 301 may be an AI model that performs actions to determine the position of a bounding box through object detection and to determine the coordinates of the bounding box. For example, the first AI model 301 may be trained to take an ID card image 305 as input, divide the ID card image 305 into a grid of a preset size, and predict the probability that information for the first area 410 and information for the second area 420 exist in the corresponding area of each grid cell. Based on the divided grid, the first AI model 301 may predict the presence and/or location of the information of the first area 410 and the information of the second area 420 within the area, and set a bounding box at the corresponding location. According to an embodiment, the first AI model 301 may be trained to acquire coordinate information of the bounding boxes of the first area and the second area within the ID card image 305. However, the first area 410 and second area 420 recognized by the first AI model 301 according to an embodiment are not limited to box shapes, and various methods related to image segmentation may be applied. For example, the first AI model 301 may be an AI model that performs classification.

According to an embodiment, the first AI model 301 may be trained to acquire the type of user information contained within the first area 410 and the type of image defect contained within the second area 420 within the ID card image 305, respectively. For example, the first AI model 301 may be trained to recognize the information in the first area 410 and to acquire which type of user information contained within that first area 410 corresponds to a particular type of user information, such as the user's photograph, ID issuance date, ID number, user's name, user's resident registration number, or user's address. For example, the first AI model 301 may be trained to recognize information in the second area 420 related to the image defects and to acquire which type of image defect contained in the second area 420 corresponds to among various types of image defects such as light reflection, halation, scribble, overwriting, stickers, and damage due to aging. The process of training the first AI model 301 to acquire the type of user information contained within the first area 410 and the type of image defect contained within the second area 420, respectively, may be performed using various training methods related to data labeling of the AI model; however, embodiments according to the present disclosure are not limited to any specific case. The first AI model 301 may be trained using a loss function to simultaneously acquire the location and type of information in both the first area 410 and the second area 420. In this case, the loss function may include a confidence loss function that determines the presence or absence of information in each of the first area 410 and the second area 420, a localization loss function for adjusting the position of the bounding box, and a class loss function for predicting the type of information in the first area 410 and the second area 420, respectively. However, the structure and training method of the first AI model 301 mentioned are merely an embodiment and the first AI model 301 used in embodiments may vary. The scope of embodiments should not be interpreted as being limited by the structure of the first AI model 301. The electronic device 100 according to an embodiment may input an ID card image 305 into the first AI model 301 to obtain information of the first area 410 and information of the second area 420, and, based on the obtained information of the first area 410 and information of the second area 420, it may determine whether user information within the ID card image 305 is identifiable.

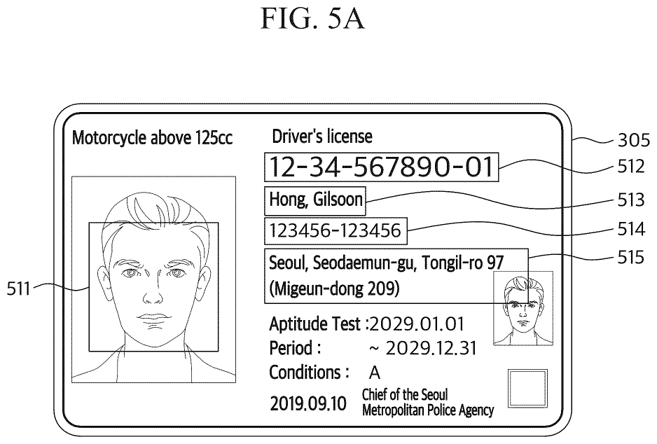

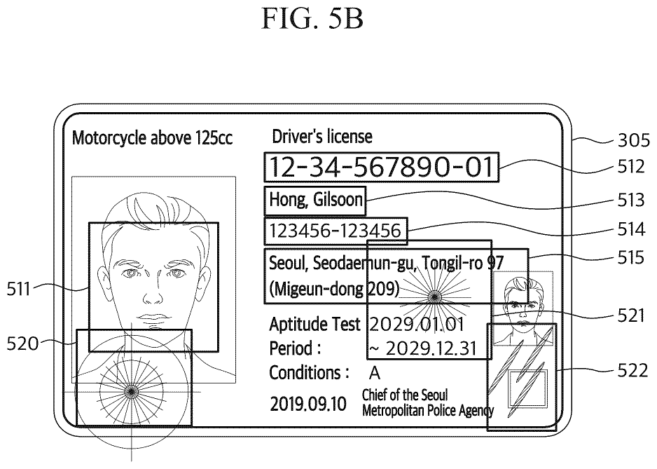

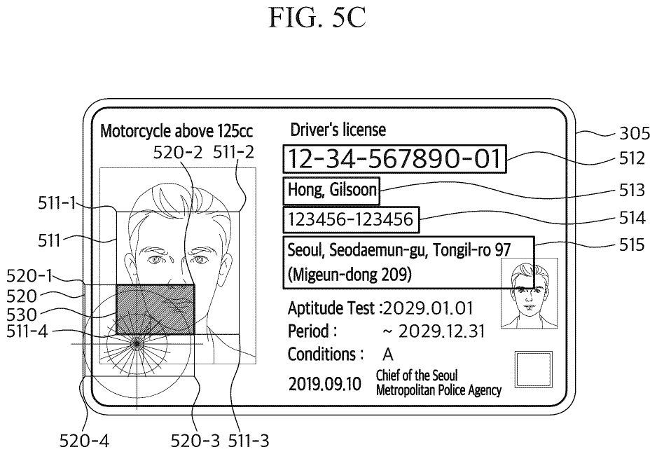

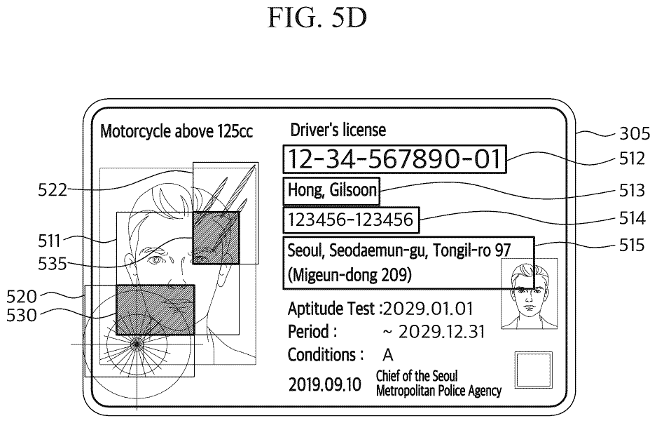

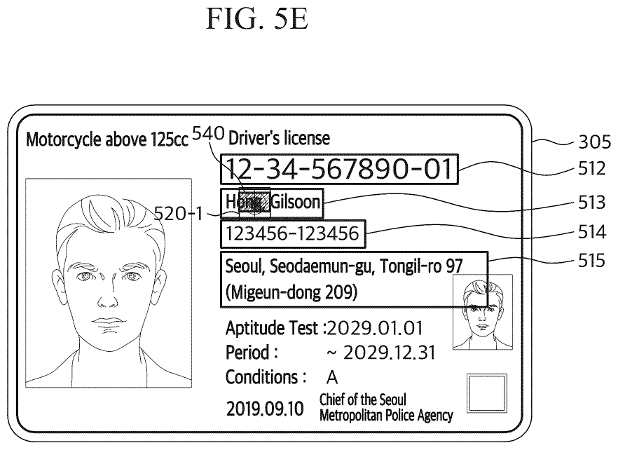

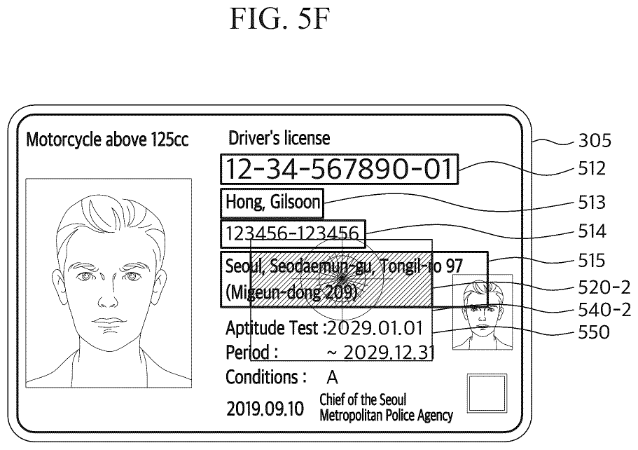

FIGS. 5A to 5F are diagrams illustrating an embodiment for detecting a first area and a second area on an ID card image in a method for capturing an ID card image according to an embodiment.

Referring to FIG. 5A, the electronic device 100 according to an embodiment may input the ID card image 305 into the first AI model, as explained in FIG. 2, to obtain information of the first area related to user information. In this case, the first area related to user information may refer to areas containing user information such as the user's photograph area 511, ID number area 512, user's name area 513, user's resident registration number area 514, and user's address area 515 on the ID card image 305. Although the disclosure has mentioned examples of user information, embodiments described herein are not limited to the specific cases mentioned. Depending on the various types of ID cards used for verification, information such as the issuance date of the ID card may also constitute user information. The first areas may be acquired, for example, through the first AI model as described in FIG. 2. According to an embodiment, the electronic device 100 may acquire information of the first area by utilizing the first AI model trained to recognize at least one area where user information is obtainable as the first area for each pre-stored ID type, after identifying the type of the ID card image 305. For example, referring to FIG. 5A, the first AI model of the electronic device 100 may be trained to recognize the user's photograph area 511, ID number area 512, user's name area 513, user's resident registration number area 514, and user's address area 515, from which user information may be obtained on a driver's license, as the first areas.

Referring to FIG. 5B, examples of one or more second areas related to image defects on the ID card image 305 can be seen. For example, image defects on the ID card image 305 may include image defects that obscure information on the ID card image 305, such as a light reflection area 520, halation area 521, and deterioration area 522 due to aging. Although examples of image defects mentioned herein include light reflection, halation, and deterioration due to aging, embodiments described herein are not limited to the specific cases mentioned, and various other defects obscuring specific areas of the ID card image 305 depending on the shooting conditions of the ID (e.g., scribble areas, overwritten areas, sticker areas) may also constitute image defects. The second areas may be obtained, for example, through the first AI model as described in FIG. 2. When the first areas 511, 512, 513, 514 and 515 obtained in the embodiment described with reference to FIG. 5A and the second area related to image defects on the ID card image 305 are determined not to overlap with each other, the electronic device 100 according to an embodiment may determine that capturing the ID card image 305 is possible to acquire user information. As another example, referring to FIG. 5B, the electronic device 100 may determine that capturing the ID card image 305 is not possible to acquire user information if some (for example, 511, 514 and 515) of the first areas 511, 512, 513, 514 and 515, and the second areas 520, 521 and 522 related to image defects on the ID card image 305 are determined to overlap with each other.

Referring to FIG. 5C, the electronic device 100 according to an embodiment inputs the ID card image 305 into the first AI model to obtain coordinate information indicating the locations of the first area (e.g., 511, 512, 513, 514, 515) related to user information and the second area (e.g., 520) related to image defects. According to an embodiment, the coordinate information for each of the first area and second area may be calculated based on the shape of each of the first area and second area. For example, if the shapes of the first area and second area are rectangles, the coordinate information for the first area and second area may be defined as coordinate information indicating the vertex positions of each rectangle on the ID card image. The following description explains that the electronic device 100 acquires information about the user's photograph area 511 and the light reflection area 520, and based on the acquired information about the user's photograph area 511 and the light reflection area 520, determines whether the user information within the ID card image 305 is identified. However, embodiments according to this disclosure are not limited to this specific case.

According to an embodiment, the information of the user's photograph area 511 among the first areas acquired by the electronic device 100 may include coordinate information 511-1, 511-2, 511-3 and 511-4 of the user's photograph area 511 on the ID card image 305. Furthermore, the information of the light reflection area 520 among the second areas acquired by the electronic device may include coordinate information 520-1, 520-2, 520-3 and 520-4 of the light reflection area 520 on the ID card image 305. The electronic device 100 may determine whether the user's photograph area 511 and the light reflection area 520 overlap based on the coordinate information 511-1, 511-2, 511-3 and 511-4 of the user's photograph area 511 and the coordinate information 520-1, 520-2, 520-3 and 520-4 of the light reflection area 520. In this case, the process by which the electronic device 100 determines whether the user's photograph area 511 and the light reflection area 520 overlap involves comparing the coordinate information 511-1, 511-2, 511-3 and 511-4 of the user's photograph area 511 and the coordinate information 520-1, 520-2, 520-3 and 520-4 of the light reflection area 520. For example, as shown in FIG. 5C, if the user's photograph area 511 and the light reflection area 520 are determined to overlap, the electronic device 100 may obtain a ratio concerning the degree of overlap. The ratio concerning the degree of overlap may be determined based on the ratio of the size of the overlapping area 530 between the user's photograph area 511 and the light reflection area 520 to the size of the user's photograph area 511. If the ratio of the size of the overlapping area 530 between the user's photograph area 511 and the light reflection area 520 to the size of the user's photograph area 511 exceeds a first threshold that serves as a criterion for determining whether the ID card image 305 is to be captured, it may control the user terminal to display first detailed information about the user information for capturing the ID card image 305. Even if defects exist on the ID card image, the electronic device 100 may determine that capturing an ID card image for acquiring user information is possible when the overlap ratio between the first area and second area is below the first threshold, and perform the optical character recognition described below to substantially acquire user information, which reduces user inconvenience. When the overlap ratio exceeds the first threshold, it determines that capturing the ID card image is impossible and prevents proceeding to the optical character recognition process, which eliminates unnecessary information processing processes.

Referring to FIG. 5D, the electronic device 100 according to an embodiment inputs the ID card image 305 into the first AI model to obtain information of the first area (e.g., 511, 512, 513, 514, 515) related to user information and information of the second area (e.g., 520, 522) related to image defects. Hereinafter, it is described that the electronic device 100 acquires information of the user's photograph area 511, light reflection area 520, and damaged area 522, and determines whether the user information within the ID card image 305 is identifiable based on the acquired information about the user's photograph area 511, the light reflection area 520 and the damaged area 522. However, embodiments according to this disclosure are not limited to this specific case.

As shown in FIG. 5D, when the number of second areas is plural, including the light reflection area 520 and the damaged area 522, the electronic device 100 obtains the ratio of the total sum of the size of the overlapping area 530 between the user's photograph area 511 and light reflection area 520 and the size of the overlapping area 535 between the user's photograph area 511 and the damaged area 522 to the size of the user's photograph area 511. If the ratio of the total size of the overlapping areas exceeds the first threshold, the electronic device 100 may control the user terminal to display first detailed information about the user's information for capturing the ID card image 305. That is, the electronic device 100 may determine in real time whether to permit capturing the ID card image 305 based not only on the information of one first area and the information of one second area within the ID card image 305, but also based on the information of one first area and the information of multiple second areas, which provides a method for capturing a stable ID card image 305 even if multiple second areas related to image defects are detected.

Referring to FIGS. 5E and 5F, an embodiment in which the first threshold serving as the criterion for the electronic device 100 according to an embodiment to display the first detailed information about the user information on the ID card image 305 has a predefined value based on the importance of user information contained within the first area (e.g., 511, 512, 513, 514, 515) can be seen. Here, the importance of user information refers to the level of importance assigned based on the strictness of verifying the authenticity of user information, which is determined considering that certain user information such as the ID number, user's name, and user's resident registration number may call for more rigorous verification than other information like the user's address to provide financial services to users under stricter ID verification standards. For example, in FIGS. 5E and 5F, assuming that the user's name contained in the user's name area 513 requires stricter verification than the user's address contained in the user address area 515 among user information, 1-1 threshold, which is the comparison target for the ratio concerning the degree of overlap between the user's name area 513 and the light reflection area 520-1 is assumed to be predefined to be lower than 1-2 threshold, which is the comparison target for the ratio concerning the degree of overlap between the user's address area 515 and the light reflection area 520-2.

More specifically, as shown in FIG. 5E, when it is determined that the user's name area 513 and the light reflection area 520-1 overlap, the electronic device 100 may obtain a ratio concerning the degree of overlap. The ratio concerning the degree of overlap may be determined based on the ratio of the size of the overlapping area 540 between the user's name area 513 and the light reflection area 520-1 to the size of the user's name area 513. If it is determined that the ratio of the size of the overlapping area 540 between the user's name area 513 and the light reflection area 520-1 to the size of the user's name area 513 exceeds the 1-1 threshold that serves as a criterion for displaying first detailed information about the user information on the ID card image 305, the electronic device 100 may determine that capturing the ID card image 305 is impossible and control the user terminal to display the first detailed information about the user information for capturing the ID card image 305.

Similarly, as in FIG. 5F, when it is determined that the user's address area 515 and the light reflection area 520-2 overlap, the electronic device 100 may obtain a ratio concerning the degree of overlap. At this time, the ratio concerning the degree of overlap may be determined based on the ratio of the size of the overlapping area 520-2 between the user's address area 515 and the light reflection area 550 to the size of the user's address area 515. The electronic device 100 may determine that it is possible to capture the ID card image 305 when the ratio of the size of the overlapping area 520-2 between the user's address area 515 and the light reflection area 550 to the size of the user's address area 515 does not exceed the 1-2 threshold that serves as a criterion for displaying the first detailed information about the user information on the ID card image 305.

Comparing FIGS. 5E and 5F more specifically, it can be seen that the ratio of the size of the overlapping area 550 between the user's address area 515 and the light reflection area 520-2 to the size of the user's address area 515 is larger than the ratio of the size of the overlapping area 540 between the user's name area 513 and the light reflection area 520-1 to the size of the user's name area 513. However, since the 1-1 threshold, which is the comparison target for the ratio concerning the degree of overlap between the user's name area 513 and the light reflection area 520-1, is predefined to be lower than the 1-2 threshold, which is the comparison target for the ratio concerning the degree of overlap between the user's address area 515 and the light reflection area 520-2, the electronic device 100 may control the user terminal to display the first detailed information about the user information for capturing the ID card image 305 in the case of FIG. 5E, even though the ratio of the size of the overlapping area 540 between the user's name area 513 and the light reflection area 520-1 to the size of the user's name area 513 in FIG. 5E is smaller than the ratio of the size of the overlapping area 550 between the user's address area 515 and the light reflection area 520-2 to the size of the user's address area 515 in FIG. 5F. Meanwhile, in FIG. 5F, it may be determined that the user information for capturing the ID card image 305 is obtainable. The importance of the user information and the threshold setting mentioned above are illustrative, and embodiments according to this disclosure are not limited to the specific cases mentioned.

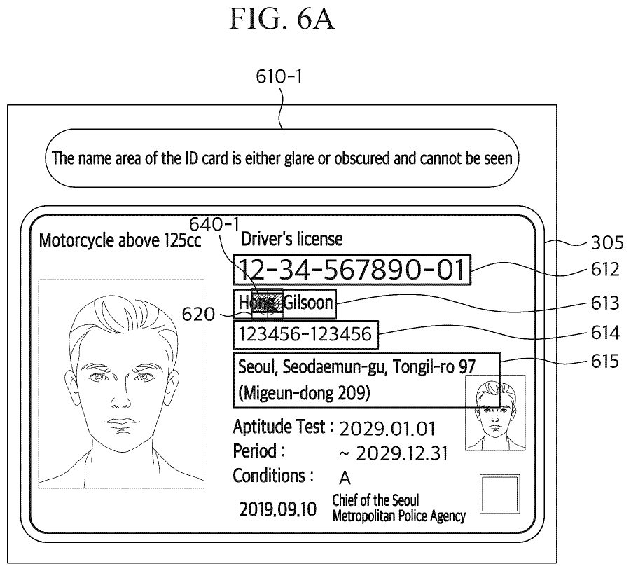

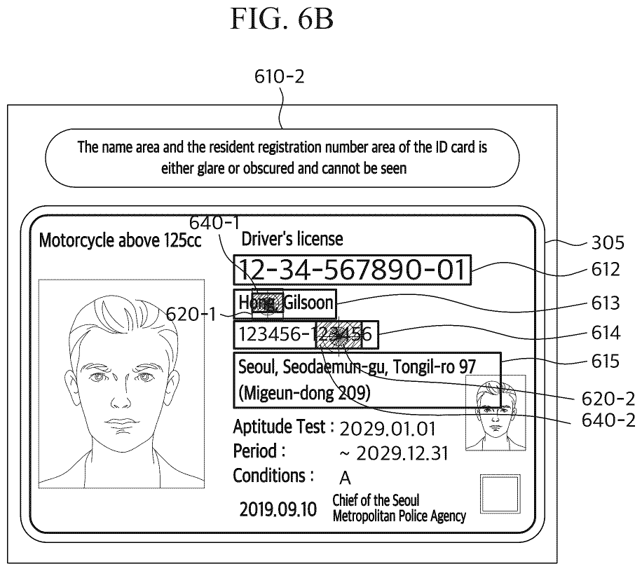

FIGS. 6A and 6B are diagrams illustrating a process for providing detailed information about user information in a method for capturing an ID card image according to an embodiment.

Referring to FIG. 6A, the electronic device 100 according to an embodiment may control the user terminal to display first detailed information 610-1 regarding the user information for capturing the ID card image 305 when it determines that the first area within the ID card image 305 overlaps with the second area, as described previously in FIGS. 5A through 5F and the acquired ratio concerning the degree of overlap exceeds a threshold.

According to an embodiment, the first detailed information 610-1 about the user information for capturing the ID card image 305 may include detailed information about which user information on the ID card image 305 is not recognized and for what reason, as shown in FIG. 6A. The electronic device 100 may be configured to display the first detailed information 610-1 corresponding to the second area, including the type of image defect (e.g., scribbles, overwriting, stickers, damages due to aging, shadows, user's fingers, light reflection areas, halation areas, and/or areas damaged due to aging).

Referring to FIG. 6B, the detailed information about the user information provided by the electronic device 100 according to an embodiment may be provided in a situation where at least one of the previously described user information items is not identifiable. That is, the electronic device 100 may identify the type and number of the first areas where the ratio of the size of overlapping area thereof with the second areas 620-1, 620-2 to the size thereof exceeds a threshold, making identification of the information difficult, among the first areas 612, 613, 614 and 615. According to an embodiment, the electronic device 100 may be configured to display second detailed information 610-2 including the type of user information within the first area where information is difficult to identify on the ID card image, based on the case where the number of the first areas where identification of the information is difficult due to the second areas 620-1, 620-2 is greater than or equal to a preset value and/or the number and/or type of the user information corresponding to the first areas where identification of the information is difficult due to the second areas 620-1, 620-2 (e.g., three types of user information that are difficult to identify: name, resident registration number, driver's license number, and user's photograph).

For example, there may be a case where the preset value is 2, and, as shown in FIG. 6B, a light reflection area 620-1 exists within the user's name area 613, making identification of the information difficult, and a light reflection area 620-2 exists within the user's resident registration number area 614, making identification of the information difficult. In the case of FIG. 6B in an embodiment, the number of the first areas where the ratio of the size of the overlapping area with the second area exceeds the threshold may be two. In an embodiment, the electronic device 100 may provide the second detailed information 610-2 about the user information for capturing the ID card image, thereby providing information about which pieces of user information for capturing the ID card image are not identifiable.

The detailed information 610-1, 610-2 regarding user information for capturing an ID card image 305 according to an embodiment may be displayed on the display of the user terminal in at least one of the upper, lower, left, or right areas of the ID card image 305, or it may be provided on a portion of the ID card image 305 by overlapping with a portion of the ID card image 305. However, the acquisition of the type of image defect corresponding to the second area and the type of user information contained within the first area where the second area overlaps is not limited to being performed by the electronic device 100 in embodiments according to the present disclosure. As mentioned earlier in relation to the first AI model 301, cases where the first AI model 301 acquires the type of user information and the type of image defect through various training methods related to data labeling of the AI model may also be included in embodiments according to the present disclosure.

Additionally, the electronic device 100 may provide information regarding image defects related to the first area, which caused the provision of detailed information 610-1, 610-2 on the ID card image 305 about the user information for capturing the ID card image 305, in the form of an image. The electronic device 100 may acquire information about the first area, including coordinate information of the first area, and information about the second area, including coordinate information of the second area, and control the user terminal to display the first detailed information about the user information for capturing the ID card image 305 based on the coordinate information of the first area and the coordinate information of the second area. As seen in FIG. 5E, the electronic device 100 may be configured to cause the user terminal to display an overlapping area 540 between a light reflection area 520-1 and a user's name area 513, in an emphasized form on the ID card image 305, within the ID card image 305.

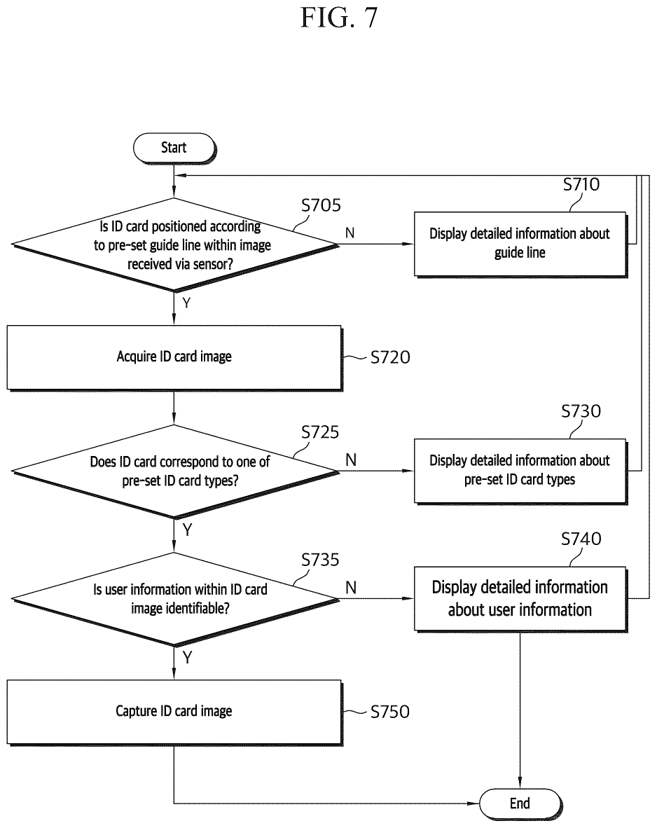

FIG. 7 is a flowchart illustrating an overall process of capturing an ID card image in a method for capturing an ID card image according to an embodiment.

Referring to FIG. 7, the electronic device 100 according to an embodiment may determine whether an ID card is positioned according to the pre-set guide line within an image received via the sensor in operation S705. The electronic device 100 according to an embodiment determines whether the ID card is positioned according to the pre-set guide line within the image received via the sensor, as described earlier in relation to FIG. 2. If it is determined that the ID card is positioned according to the pre-set guide line, the ID card image may be acquired based on the guide line. If it is determined that the ID card is not positioned according to the pre-set guide line, it may control the user terminal to display detailed information about the guide line in operation S710.

The electronic device 100 according to an embodiment may acquire an ID card image in operation S720 if it determines in operation S705 that the ID card is positioned according to the pre-set guide line within the image received via the sensor. In an embodiment, the electronic device 100 may acquire an image included within the guide line as the ID card image if the area corresponding to the ID card within the image received via the sensor satisfies predefined conditions based on the area corresponding to the predefined guide line.

The electronic device 100 according to an embodiment may determine in operation S725 whether an ID card contained in the ID card image corresponds to one of the pre-set ID card types. The electronic device 100 may input the ID card image into the first AI model to determine the type of ID card contained in the ID card image as described above, and determine whether the determined type of ID card corresponds to one of the pre-set ID card types. In operation S725, if the electronic device 100 according to an embodiment determines that the ID card does not correspond to any of the pre-set ID card types, it may control the user terminal to display detailed information about the pre-set ID card types in operation S730. The detailed information about the pre-set ID card types may include the type of the ID card contained in the ID card image acquired by the electronic device 100 for ID card capture and/or detailed information about the ID card type required for capturing the ID card image. If the electronic device 100 determines that the ID card contained in the ID card image does not correspond to the pre-set ID type, it may repeat the process of acquiring the ID card image in operation S720 based on whether the ID card is positioned according to the pre-set guide line in operation S705.

The electronic device 100 according to an embodiment may determine in operation S735 whether user information within the ID card image is identifiable. The electronic device 100 may acquire information of the first area related to user information within the ID card image and information of the second area related to image defects within the ID card image, and determine whether the user information within the ID card image is identifiable based on the information of the first area and the information of the second area. Here, the determination of whether the user information is identifiable may be implemented as a process of determining whether the first area and the second area overlap by the previously described embodiments, rather than a process in which the electronic device 100 directly acquires the user information contained within the first area to make the determination.

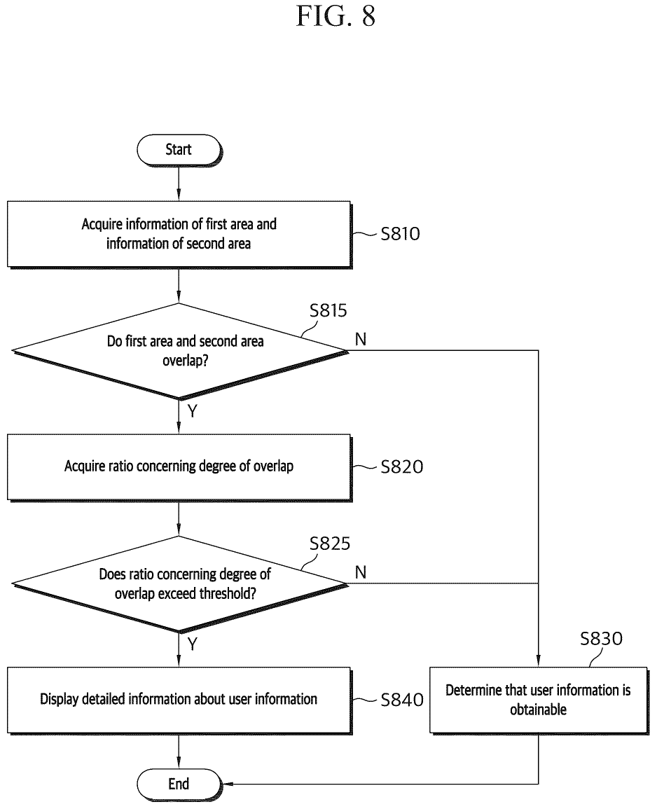

In an embodiment, the electronic device 100 may determine whether the first area and the second area overlap based on the coordinate information of the first area and the coordinate information of the second area obtained through the first AI model. In an embodiment, if the electronic device 100 determines that the first area and the second area do not overlap, it may determine that the user information within the ID card image is identifiable and may capture the ID card image in operation S750. In an embodiment, if the electronic device 100 determines that the first area and the second area overlap, it may obtain a ratio concerning the degree of overlap between the first area and the second area. If the ratio concerning the degree of overlap exceeds a threshold, in operation S740, it may control the user terminal to display first detailed information corresponding to the user information in the first area that should not be overlapped by the second area for capturing the ID card image, and it may return to operation S705 to repeat the process of acquiring the ID card image. In an embodiment, the electronic device 100 may identify the number of first areas acquired through the first AI model, and if the number of first areas is less than a preset value, it may control the user terminal to display second detailed information about the user information for capturing the ID card image in operation S740. Then, it may repeat the process of acquiring the ID card image in operation S720 based on whether the ID is positioned according to the pre-set guide line in operation S705. The process by which the electronic device 100 in an embodiment displays detailed information based on information about the first area and second area acquired from the ID card image in operation S735 is described in detail with reference to FIG. 8.

According to an embodiment, when the electronic device 100 determines that the user information within the ID card image is identifiable in operation S735, it may determine that it is possible to capture the ID card image, and then capture the ID card image in operation S750.

FIG. 8 is a flowchart illustrating an overall process of providing detailed information about user information in a method for capturing an ID card image according to an embodiment.

Referring to FIG. 8, the electronic device 100 performing the method of capturing an ID card image according to an embodiment may acquire information of the first area and/or information of the second area in operation S810. The electronic device 100 according to an embodiment may acquire coordinate information of the first area and coordinate information of the second area in operation S810. The electronic device 100 may acquire the coordinate information of the first area and the coordinate information of the second area, for example, from the first AI model 301 described earlier. Alternatively, it may acquire the coordinate information of the first area and the coordinate information of the second area based on pre-set coordinate information on an ID card image input interface provided to the user.

According to an embodiment, the electronic device 100 may determine in operation S815 whether the first area and the second area overlap based on the information of the first area and the information of the second area. For example, the electronic device 100 may input an ID card image into the first AI model 301 to obtain information related to the first area concerning user information within the ID card image and information related to the second area concerning image defects within the ID card image. In this case, the first AI model may be an AI model based on an object detection algorithm as described earlier. In this case, the user information may include at least one of the user's photograph, ID number, name, resident registration number, and address, and the image defects may include at least one of light reflection, halation, and damages. The information of the first area may include coordinate information of the first area on the ID card image, and the information of the second area may include coordinate information of the second area on the ID card image. Additionally, the information of the first area may include the location and/or type of user information contained within the first area, and the information of the second area may include the location and/or type of image defects contained within the second area.

The electronic device 100 may determine in operation S815 whether the first area and the second area overlap based on the coordinate information of the first area and the coordinate information of the second area. For example, the electronic device 100 may determine whether the first area 410 and the second area 420 overlap based on the coordinate information of the bounding box set at the location of the first area and/or the second area, after the first AI model 301 predicts the presence and/or location of the information of the first area and the information of the second area, respectively. For example, the coordinate information of the first area may include the coordinates of the top-left point of the first area, the top-right point of the first area, the bottom-right point of the first area, and the bottom-left point of the first area. Similarly, the coordinate information for the second area may include the coordinates of the top-left point of the second area, the top-right point of the second area, the bottom-right point of the second area, and the bottom-left point of the second area. In this case, the coordinates of each respective point may include the X-coordinate of the point based on the X-axis and the Y-coordinate of the point based on the Y-axis perpendicular to the X-axis.

According to an embodiment, the electronic device 100 sets the reference point of the coordinate information to the leftmost bottom pixel of the ID card image. If the relationship between the coordinate information of the first area and the coordinate information of the second area satisfies all the conditions of Equations 1 through 4 below, the first area and the second area may be determined to overlap.

$$X - coordinate of the top - left point or bottom - left point of the first area < X - coordinate of the top - left point or bottom - left point of the second area < X - coordinate of the top - right point or bottom - right point of the first area \qquad [ Equation 1 ]$$

$$X - coordinate of the top - left point or bottom - left point of the first area < X - coordinate of the top - right point or bottom - right point of the second area < X - coordinate of the top - right point or bottom - right point of the first area \qquad [ Equation 2 ]$$

$$Y - coordinate of the bottom - left point or bottom - right point of the first area < Y - coordinate of the bottom - left point or bottom - right point of the second area < Y - coordinate of the top - right point or top - left point of the first area \qquad [ Equation 3 ]$$

$$Y - coordinate of the bottom - left point or bottom - right point of the first area < Y - coordinate of the top - left point or top - right point of the second area < Y - coordinate of the top - right point or top - left point of the first area \qquad [ Equation 4 ]$$

However, Equations 1 through 4 are exemplary mathematical expressions computed during the process of determining whether the first area and the second area overlap, assuming the electronic device 100 sets the shapes of the first area and the second area to be rectangular; embodiments according to this disclosure are not limited to the specific conditions mentioned above.

If the electronic device 100 according to an embodiment determines in operation S815 that the first area and the second area do not overlap, it may determine in operation S830 that user information is obtainable and that an ID card image is to be captured. For example, the electronic device 100 may capture the ID card image as described in operation S750 above.

According to an embodiment, the electronic device 100 may obtain a ratio concerning the degree of overlap between the first area and the second area when it is determined in operation S820 that the first area overlapping with the second area is present. For example, the electronic device 100 may determine whether the first area and the second area overlap based on coordinate information of the first area and coordinate information of the second area, and if it is determined that the first area overlaps with the second area, it may obtain a ratio concerning the degree of overlap. For example, the ratio concerning the degree of overlap may be determined based on the ratio of the size of the area where the first area and the second area overlap to the size of the first area. For example, if there are multiple second areas, the electronic device 100 may obtain the ratio of the total sum of the sizes of the areas where the first area and each of the multiple second areas overlap to the size of the first area.

If it is determined in operation S825 that the ratio concerning the degree of overlap exceeds a threshold, the electronic device 100 performing the method of capturing an ID card image according to an embodiment may control the user terminal to display either the first detailed information or the second detailed information about the user information in operation S840. In an embodiment, whether the ratio concerning the degree of overlap exceeds the threshold may be determined based on thresholds set differently based on the importance of the user information, as described earlier.

The electronic device 100 may control the user terminal to display the first detailed information or the second detailed information, as explained with reference to FIGS. 6A and 6B, which includes the type of image defects corresponding to the second area. For example, the electronic device 100 may control the user terminal to display the second detailed information containing information about which pieces of user information for capturing the ID card image are not identifiable. Through this, the electronic device 100 may guide the user that the ID card image should be submitted normally without tilting or cropping areas on the submitted ID card image, while simultaneously providing real-time feedback on which information among the user information is not identifiable on the ID card image or is obscured by which defect.

If it is determined in operation S825 that the ratio concerning the degree of overlap is below a threshold, the electronic device 100 according to an embodiment may determine in operation S830 that the user information is obtainable and that the ID card image is to be captured. For example, the electronic device 100 may capture the ID card image as described in operation S750 above.

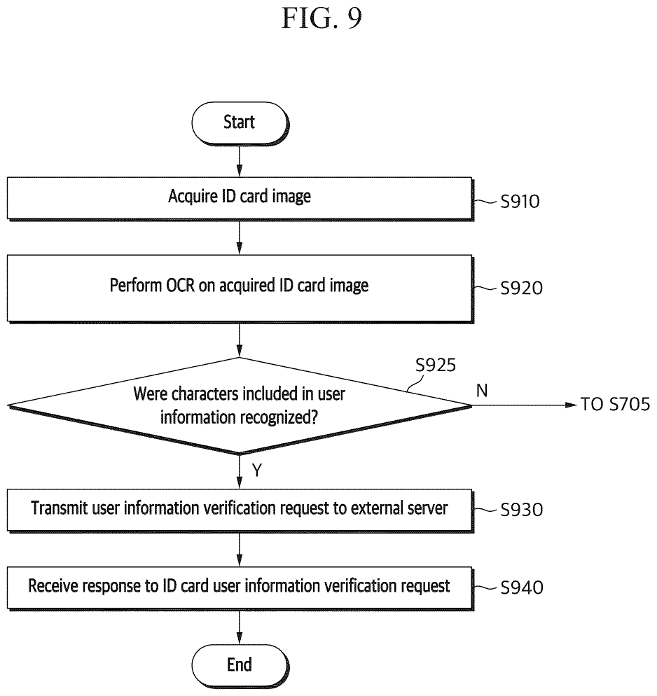

FIG. 9 is a flowchart illustrating an overall process of performing user information verification after capturing an ID card image in a method for capturing an ID card image according to an embodiment.

Referring to FIG. 9, the electronic device 100 according to an embodiment may capture an ID card image in operation S910. According to an embodiment, operation S910 in FIG. 9 may correspond to operation S750 in FIG. 7. As previously described, the electronic device 100 may capture the ID card image within the image received via the sensor in operation S910 when the following conditions are met for a certain period of time: it is determined that the ID card is positioned according to the pre-set guide line; the ID card contained in the ID card image corresponds to one of the pre-set ID card types; and the user information within the ID card image is identifiable. The electronic device 100 may perform an operation to convert the image received via the sensor into digital data concerning pixels containing color and brightness information and store the digital data.

The electronic device 100 according to an embodiment may perform optical character recognition on the captured ID card image in operation S920. The electronic device 100 may perform preprocessing on the captured ID card image, including noise removal, contrast adjustment, image binarization, and image rotation and resizing, and then perform an operation to detect at least one of the ID number, name, resident registration number, and address within the ID card image.

In an embodiment, the electronic device 100 may determine in operation S925 whether characters included in the user information are recognized. In an embodiment, the electronic device 100 may determine that characters included in the user information are not recognized if the number of unrecognized characters exceeds a preset threshold. For example, the electronic device 100 may determine that characters included in the user information are not recognized if the number of unrecognized characters is 20% or more of the total number of characters. For example, the electronic device 100 may determine that the characters included in the user information are not recognized if, for a resident registration number included in the user information, three or more characters (representing 20% or more of the total 13 characters) are not identified. For example, the electronic device 100 may determine that the characters included in the user information are not recognized if, for each recognized character, a pre-set character area required to be recognized for identification is not identified. For example, for the digit 8, since more than 50% of the lower area must be identified to distinguish it from the digit 9, the electronic device 100 may set the pre-set character area where more than 50% of the lower area required to be identified for the recognition of the digit 8, and may determine whether the character included in the user information has been recognized.

For example, the electronic device 100 may perform operations on the numbers contained within the resident registration number during the process of determining whether characters included in the user information are recognized in operation S925. For example, if the ID card included in the ID card image is a resident registration card, and the issuance date of the resident registration card is prior to a pre-set point in time (e.g., October 2020), the electronic device 100 may multiply the first digit of the first 12 digits of the 13-digit resident registration number by 2, then the second digit by 3, the third digit by 4, 5, 6, 7, 8, and 9 in sequence, then after 9, multiply again in the order of 2, 3, 4, and 5. Afterward, it may perform the operation of adding all the results obtained by multiplying each of the 12 digits of the resident registration number by 2 to 9. The electronic device 100 divides the sum of all these multiplied results by 11 to obtain the remainder value. Based on this verification number, which is 11 minus the remainder, it may determine the character included in the user information. The electronic device 100 may determine the characters included in the user information by considering the relationship between the issuance date of the resident registration card after the user's age (e.g., 17 years old) based on the first 6 digits of the resident registration number and the resident registration number obtained through optical character recognition of the resident registration card. For another example, if the ID card contained in the ID card image is a driver's license of motorcycle above 125cc, the electronic device 100 may determine the characters included in the user information by considering the relationship between the issuance date of the driver's license after the user's age (e.g., 16 years old) based on the first 6 digits of the resident registration number and the resident registration number obtained through optical character recognition of the driver's license. For yet another example, if the ID card contained in the ID card image is a driver's license other than a driver's license of motorcycle above 125cc, the electronic device 100 may determine the characters included in the user information by considering the relationship between the issuance date of the driver's license after the user's age (e.g., 18 years old) based on the first 6 digits of the resident registration number and the resident registration number obtained through optical character recognition of the driver's license. In summary, the electronic device 100 may determine the characters included in the user information by performing operations on the numbers included in the user information according to the pre-set ID card types during the process of determining whether the character included in the user information is recognized in operation S925. If the character is not determined, then the electronic device 100 may determine that the character included in the user information is not recognized.

However, the conditions for determining whether character recognition is possible, as provided in the embodiments for the operation of the electronic device 100 for recognizing characters included in user information based on optical character recognition, are merely illustrative for the sake of explanation and should not be interpreted as limiting the operation of the electronic device 100.

According to an embodiment, if the electronic device 100 determines in operation S925 that characters included in the user information are not recognized, it may return to operation S705 to reacquire the ID card image. That is, the electronic device 100 determines whether the ID card is positioned according to the pre-set guide line within the image received via the sensor to reconfirm whether the user information within the ID card image described earlier is identifiable. If it is determined that the ID card is positioned according to the pre-set guide line, the electronic device 100 reacquires the ID card image based on the guide line, reacquires the information for the first area and the information for the second area, and re-determines whether the user information within the reacquired ID card image is identifiable. The electronic device 100 may then perform the operations described earlier up to operation S750 of FIG. 7 for capturing the ID card image again, based on the reacquired ID card image.

According to an embodiment, the electronic device 100 may transmit a user information verification request to an external server 200 based on the characters included in the user information determined in operation S930, if it determines in operation S925 that the characters included in the user information are recognized.

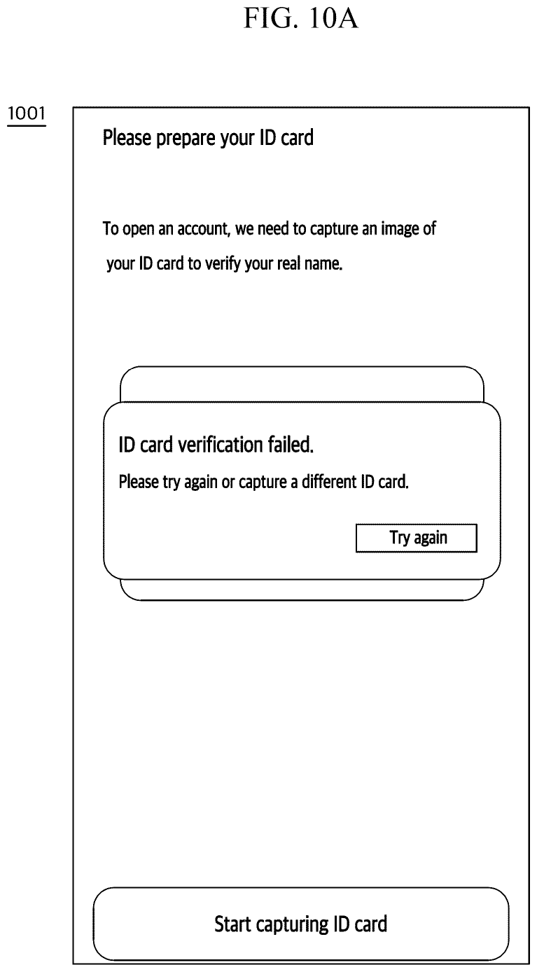

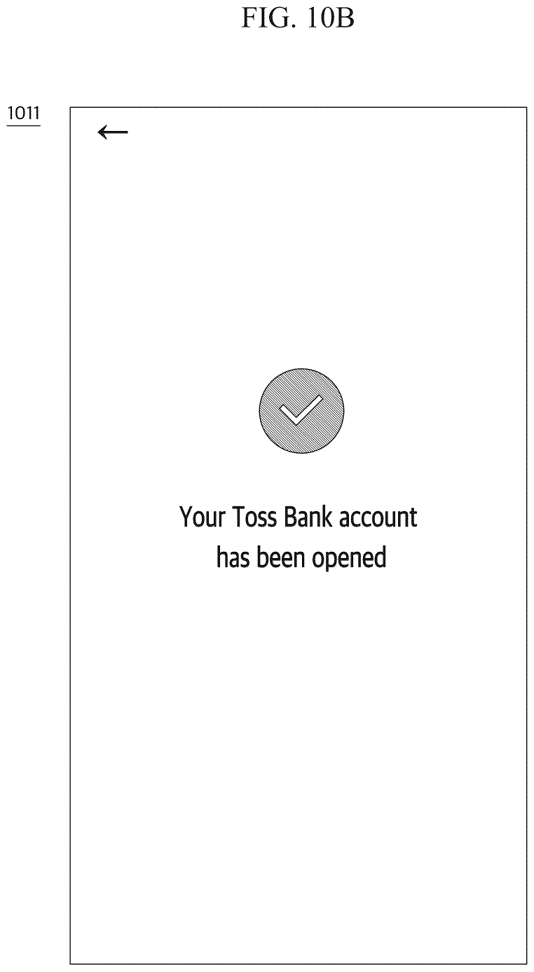

The electronic device 100 according to an embodiment may receive a response to the ID card user information verification request from the external server 200 in operation S940. For example, if the electronic device 100 receives a response from the external server 200 indicating failure of the ID card user information verification, it may display ID card verification rejection information, as shown in FIG. 10A, on the user terminal. For example, if the electronic device 100 receives a response from the external server 200 indicating successful verification of the ID user information, it may provide ID verification approval information as shown in FIG. 10B.

FIGS. 10A and 10B are diagrams illustrating an example of providing a verification result of an ID card in a method for capturing an ID card image according to an embodiment.

Referring to FIG. 10A, a first interface 1001 related to the ID verification result provided by the electronic device 100 according to an embodiment can be seen. Referring to FIG. 10A, the embodiment in which the first interface 1001 is displayed corresponds to the case where verification fails based on the result of requesting verification from the external server 200 after capturing the ID card image, which is different from an embodiment in which a capture failure occurs during the ID card image capture process performed by the first AI model (e.g., capture failure of the ID card image due to the second area overlapping the first area, or failure to obtain user information despite capturing the ID card image, due to failure to derive the corresponding characters for the user information after optical character recognition of the user information on the ID card image). Therefore, the first interface 1001 may be configured differently from the interfaces such as those shown in FIGS. 6A and 6B. For example, while FIGS. 6A and 6B are intended to provide the user with failure reasons related to the information about the first area and/or the second area as reasons for the failure to capture the ID card image, the first interface 1001 in FIG. 10A may be intended to provide information that the verification of the ID card has been rejected.

According to an embodiment, the electronic device 100 may further be configured to receive information regarding the reason for the verification failure from the external server 200 (e.g., whether the ID card is counterfeit and not registered with the external server 200, whether the amount or accuracy of user information required by the external server 200 for verification falls below the standard, etc.). In this case, the electronic device 100 may be configured to transmit the received information regarding the reason for the verification failure to the user terminal, causing the user terminal to display the reason for the verification failure via the first interface 1001.

According to an embodiment, the electronic device 100 may be configured to perform operation S705 again to re-capture the ID card when the user selects an object displayed on the first interface 1001.

Referring to FIG. 10B, a second interface 1011 related to the identity verification result provided by the electronic device 100 according to an embodiment can be seen. Through this second interface 1011, the electronic device 100 may provide information related to the financial service requested by the user (e.g., account opening service) that was the purpose of the ID verification. This ensures that the capture of the ID card image implicitly and appropriately meets the authentication criteria for the financial service, even if the user is unaware of the ID card capture. The electronic device 100 may also provide information that the ID card image has passed the ID verification.

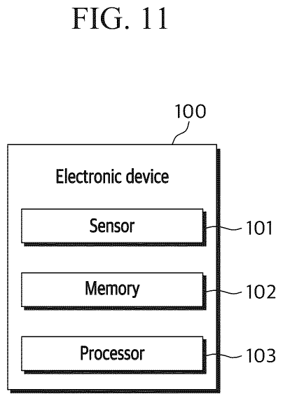

FIG. 11 is a block diagram showing the structure of an electronic device performing a method for capturing an ID card image according to an embodiment.

FIG. 11 is a block diagram showing the structure of an electronic device according to an embodiment.

Referring to FIG. 11, the electronic device 100 may include a sensor 101, a memory 102, and a processor 103 according to an embodiment. The electronic device 100 shown in FIG. 11 depicts only the components related to this embodiment. Therefore, it will be understood by those skilled in the art related to this embodiment that other common components may be included in addition to the components illustrated in FIG. 11.

For example, the electronic device 100 may include a communication device (not shown) comprising one or more transceivers. The communication device is a device for performing wired/wireless communication and may communicate with external electronic devices. The external electronic devices may be terminals or servers. Furthermore, the communication technologies utilized by the communication device may include Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, Near Field Communication (NFC), among others.

For example, the electronic device 100 may include a display part (not shown). The display part may visually provide information to an external entity (e.g., a user) of the electronic device 100. The display part may provide the user with an image received by the electronic device 100 via the sensor 101. The display part may provide the user with detailed information about the pre-set ID card types, as previously described. The display part may provide the user with detailed information about the pre-set guide line. The display part may provide the user with detailed information about user information for capturing the ID card image. The display part may provide the user with an interface regarding the ID card verification result.

According to an embodiment, the sensor 101 may receive and capture images and videos. According to an embodiment, the sensor 101 may include one or more lenses, image sensors, image signal processors, or flashes.

The memory 102 according to an embodiment may store information for performing at least one method described in FIGS. 1 through 11. The memory 102 may store one or more instructions executed by one or more processors 103. The memory 102 may be referred to as storage and may be volatile or non-volatile memory. Furthermore, the memory 102 may store one or more instructions for performing the operation of the processor 103 and may temporarily store data stored on the platform or stored in external memory.

The processor 103 may control the overall operation of the electronic device 100 and process data and signals. The processor 103 may be composed of at least one hardware unit. Furthermore, the processor 103 may operate based on one or more software modules generated by executing program code stored in the memory 102. The processor 103 may include a processor and memory, in which the processor may execute program code stored in the memory to control the overall operation of the electronic device 100 and process data and signals. Furthermore, in an embodiment, the processor 103 may be included in a controller.

For example, the processor 103 may be configured to determine whether an ID card within an image received via the sensor is positioned according to the pre-set guide line. If the processor 103 determines that the ID card is positioned according to the pre-set guide line, it may be configured to acquire an image of the ID card based on the guide line. The processor 103 may be configured to input the ID card image into the first AI model to determine whether the ID card contained in the ID card image corresponds to one of the pre-set ID card types. The processor 103 may be configured to determine whether user information is identifiable within the ID card image, and if it is determined that user information is identifiable within the ID card image, it may be configured to capture the ID card image.

According to embodiments, it is possible to provide feedback in real time via a trained artificial intelligence model on an electronic device such as a user terminal used by the user, indicating whether an identification card image being captured by the user is being captured appropriately.

Furthermore, according to embodiments, when providing real-time feedback regarding an identification card being captured by the user, detailed information can be provided not only that the identification card image is being captured improperly, but also what specific issues exist with the identification card image.

The effects of the present disclosure are not limited to the effects mentioned above, and other effects not mentioned will be clearly understood by those skilled in the art from the description herein.

The electronic device according to the above-described embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present embodiment can be represented by functional block configurations and various processing steps. These functional blocks may be implemented with various numbers of hardware or/and software configurations that perform specific functions. For example, the embodiment may employ an integrated circuit configuration such as memory, processing, logic, look-up table, or the like, capable of executing various functions by control of one or more microprocessors or other control devices. Similar to that components can be implemented with software programming or software elements, this embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described embodiments are merely examples, and other embodiments may be implemented within the scope of the this disclosure.

What is claimed is:

1. A method for capturing an identification (ID) card image, the method comprising:
determining whether an ID card within an image received via a sensor is positioned according to a pre-set guide line;
acquiring an ID card image based on the guide line if it is determined that the ID card is positioned according to the pre-set guide line;
inputting the ID card image into a first artificial intelligence (AI) model to determine whether the ID card contained in the ID card image corresponds to one of pre-set ID card types;
determining whether user information within the ID card image is identifiable; and
capturing the ID card image if it is determined that the user information within the ID card image is identifiable.

2. The method of claim 1, further comprising:
controlling a user terminal to display detailed information about the pre-set ID card types required to be obtained in order to capture the ID card image if it is determined that the ID card contained in the ID card image does not correspond to any of the pre-set ID card types.

3. The method of claim 1, wherein the determining of whether the ID card is positioned according to the pre-set guide line comprises:
determining whether an area corresponding to the ID card within the image received via the sensor satisfies pre-set conditions based on an area corresponding to the pre-set guide line.

4. The method of claim 3, further comprising:
controlling a user terminal to display detailed information about the pre-set guide line where the area corresponding to the ID card required to be placed for capturing the ID card image if it is determined that the area corresponding to the ID card is not positioned according to the pre-set guide line.

5. The method of claim 1, wherein the determining of whether the user information within the ID card image is identifiable comprises:
acquiring information of a first area in the ID card image related to the user information and information of a second area in the ID card image related to image defects; and
determining whether the user information within the ID card image is identifiable based on the information of the first area and the information of the second area.

6. The method of claim 5, wherein
the information of the first area comprises coordinate information of the first area on the ID card image,
the information of the second area comprises coordinate information of the second area on the ID card image, and
the determining of whether the user information within the ID card image is identifiable comprises:
determining whether the first area and the second area overlap based on the coordinate information of the first area and the coordinate information of the second area;
obtaining a ratio concerning a degree of overlap if it is determined that the first area overlaps with the second area; and
controlling a user terminal to display first detailed information about the user information for capturing the ID card image if the ratio concerning the degree of overlap exceeds a first threshold.

7. The method of claim 6, wherein the ratio concerning the degree of overlap is determined based on a ratio of a size of an area where the first area and the second area overlap to a size of the first area.

8. The method of claim 6, wherein the first threshold has a predefined value based on an importance of the user information contained within the first area.

9. The method of claim 6, wherein
the obtaining of the ratio concerning the degree of overlap comprises obtaining, when there are multiple second areas, a ratio of a total sum of sizes of overlapping areas of the first area and the second area to the size of the first area, and
the controlling of the user terminal to display the first detailed information about the user information for capturing the ID card image comprises controlling the user terminal to display the first detailed information about the user information if the ratio of the total sum of the sizes of the overlapping areas exceeds the first threshold.

10. The method of claim 6, further comprising:
identifying a number of the first areas where the ratio of the total sum of the sizes of overlapping areas with the second area exceeds the first threshold; and
controlling the user terminal to display second detailed information about the user information for capturing the ID card image if the number of the first areas is equal to or greater than a preset value.

11. The method of claim 6, wherein the determining of whether the user information within the ID card image is identifiable comprises determining that the user information for capturing the ID card image is obtainable if it is determined that the first area does not overlap with the second area.

12. The method of claim 6, further comprising:
performing, after capturing the ID card image, optical character recognition (OCR) on the captured ID card image; and
after performing the OCR, if characters included in the user information of the captured ID card image are not recognized, reacquiring an ID card image within an image received via the sensor.

13. The method of claim 12, wherein the reacquiring of the ID card image further comprises:
acquiring information about a first area in the reacquired ID card image related to the user information and information about a second area in the reacquired ID card image related to image defects;
re-determining whether the user information within the reacquired ID card image is identifiable based on the reacquired information of the first area and the reacquired information of the second area; and
re-capturing the ID card image if the user information within the reacquired ID card image is identifiable,
the re-determining of whether the user information within the reacquired ID card image is identifiable comprises reacquiring a ratio concerning a degree of overlap between the first area and the second area within the reacquired ID card image, and
the re-capturing of the ID card image comprises re-capturing the ID card image when the ratio concerning the degree of overlap is less than or equal to a second threshold which is below the first threshold.

14. The method of claim 12, further comprising:
transmitting, when the characters included in the user information of the captured ID card image are recognized, a verification request for the user information of the ID card image to an external server; and
receiving a response corresponding to the verification request.

15. A non-transitory computer-readable storage medium having a program for executing the method of claim 1 on a computer recorded thereon.

16. An electronic device for performing a method for capturing an identification (ID) card image, the electronic device comprising:
a sensor configured to receive an image;
a memory; and
a processor coupled to the memory, wherein the processor is configured to:
determine whether an ID card within an image received via a sensor is positioned according to a pre-set guide line;
acquire an ID card image based on the guide line if it is determined that the ID card is positioned according to the pre-set guide line;
input the ID card image into a first artificial intelligence (AI) model to determine whether the ID card contained in the ID card image corresponds to one of pre-set ID card types;
determine whether user information within the ID card image is identifiable; and capture the ID card image if it is determined that the user information within the ID card image is identifiable.
